(19) United States
(12) Patent Application Publication
(10) Pub. No.: US 2013/0080263 A1
(43) Pub. Date: Mar. 28, 2013

(54) PER-VIEW CHARGING FOR VIDEO ADVERTISEMENTS

(71) Applicants: Jonathan Goldman, San Francisco, CA (US); Ozgur Sahin, San Francisco, CA (US); Jamieson R. Kerns, Santa Monica, CA (US); Jie Ren, Santa Monica, CA (US); Jyotirmaya M. Akkad, San Francisco, CA (US); Lane P. Shackleton, San Francisco, CA (US); Philippe Farhi, San Francisco, CA (US); Shishir S. Mehrotra, Los Altos, CA (US)

(72) Inventors: Jonathan Goldman, San Francisco, CA (US); Ozgur Sahin, San Francisco, CA (US); Jamieson R. Kerns, Santa Monica, CA (US); Jie Ren, Santa Monica, CA (US); Jyotirmaya M. Akkad, San Francisco, CA (US); Lane P. Shackleton, San Francisco, CA (US); Philippe Farhi, San Francisco, CA (US); Shishir S. Mehrotra, Los Altos, CA (US)

(21) Appl. No.: 13/241,653

(22) Filed: Sep. 23, 2011

(51) Int. Cl. G06Q 30/02

(52) U.S. Cl. 705/14.69

(57) ABSTRACT

Methods, systems, and apparatus, including computer programs encoded on a computer-readable storage medium, including a method for charging advertisers for advertisements. The method comprises providing a video advertisement to a user in a content page where the video advertisement includes a control for selecting an associated video for playback. The method further comprises receiving, from the user, a selection of the control. The method further comprises determining when the user is presented with the video. The method further comprises charging an advertiser associated with the video advertisement based on the determining as opposed to a time when the selection occurs.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content. When an advertiser's content item is served, the advertiser can be charged. For example, an advertiser associated with a video ad can be charged when a user clicks on a thumbnail associated with a video ad.

### SUMMARY

In general, one innovative aspect of the subject matter described in this specification can be implemented in methods that include a method for charging advertisers for advertisements. The method comprises providing a video advertisement to a user in a content page where the video advertisement includes a control for selecting an associated video for playback. The method further comprises receiving, from the user, a selection of the control. The method further comprises determining when the user is presented with the video. The method further comprises charging an advertiser associated with the video advertisement based on the determining as opposed to a time when the selection occurs.

These and other implementations can each optionally include one or more of the following features. The control can be a link to the video. The content page can be a search result page that includes a plurality of advertisements. The search result page can include a plurality of video advertisements. The determining can include determining a time after the selection of the control when the video is played for the user. The method can further comprise charging the advertiser associated with the video advertisement at the determined time as opposed to the time associated with the selection of the control. The selection of the control can comprise a click and the method further comprising determining after the click that no playback of the video occurred and not charging the advertiser for the click. The method can further comprise, after receipt of the selection, generating a first redirect for designating which advertisement from a plurality of advertisements on the content page was selected by the user to a domain associated with an advertisement delivery system that provides the video advertisement. The video advertisement can be served by an advertisement delivery system associated with a first domain and where the video plays on a web page that is hosted in a second different domain, and the method can further comprise, after receipt of the selection, generating a first redirect to the first domain that records the click and generating a second redirect to the second domain to set a cookie that records information about how to contact a charging engine and to identify which advertisement for which to record the charge. The first redirect can use a code that indicates that the selection of the control is an initial click and not a playback of the video. The second redirect can include instructions that allow billing to occur when the video is played back. Determining when the user is presented the video can include determining when the user has been presented a predetermined portion of the video and charging the advertiser only after the predetermined portion has been presented to the user. The predetermined portion can be a portion that is sufficiently long to enable the user to have skipped the video if desired. The predetermined portion can be a predetermined percentage of the video.

In general, another innovative aspect of the subject matter described in this specification can be implemented in methods that include a method for charging an advertiser at the time that a video content item is presented. The method comprises receiving a selection from a user of a video content item including a click on an advertisement associated with the video content item. The method further comprises not charging the advertiser associated with the video content item when the click occurs rather determining a time when the video content item is presented to the user. The method further comprises charging the advertiser at the time that the video content item is presented to the user.

In general, another innovative aspect of the subject matter described in this specification can be implemented in systems that include a content management system that provides content items responsive to received requests. The content management system includes a video engine that presents a video advertisement to a user and determines when the user is presented with an associated video, where the video advertisement is served by an advertisement delivery system associated with a first domain. The content management system further includes a redirector that rewrites a uniform resource locator (URL) prior to processing by a web server, where the redirector generates a first redirect for designating which advertisement from a plurality of advertisements on a content page was selected by the user to a domain associated with an advertisement delivery system that provides the video advertisement, and where the redirector generates a second redirect to a second domain to set a cookie that records charging information, the charging information including identification of the advertisement for which to record the charge. The content management system further includes a charging engine for charging an advertiser associated with the video advertisement based on the recorded charging information and further based on determining when the user is presented with the associated video as opposed to a time when the selection occurs.

In general, another innovative aspect of the subject matter described in this specification can be implemented in computer program products that include a computer program product tangibly embodied in a computer-readable storage device and comprising instructions that, when executed by a processor, perform a method for providing content. The method comprises providing a video advertisement to a user in a content page where the video advertisement includes a control for selecting an associated video for playback. The method further comprises receiving, from the user, a selection of the control. The method further comprises determining when the user is presented with the video. The method further comprises charging an advertiser associated with the video advertisement based on the determining as opposed to a time when the selection occurs.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for serving content.

FIG. 2 is a block diagram of a system for charging a content sponsor when an associated video is presented.

FIG. 3 is a flowchart of an example process for charging a content sponsor when an associated video is presented.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for charging a content sponsor when their associated video is presented (e.g., the video is viewed) as opposed to when a corresponding advertisement (“ad”) is clicked. For example, after a thumbnail for a video advertisement is clicked on a content page, a redirect can occur to an advertisement delivery system that serves the video advertisement, where the advertisement delivery system is associated with a first domain. A second redirect can occur that sets a cookie that records information about how to contact a charging engine and for which advertisement to record the charge. For example, when presentation of the advertising video starts, the advertiser associated with the video advertisement can be charged using information stored in the cookie.

Charge-per-view video content items can be used in different formats, including, but not limited to, a search-result-embedded format (e.g., a video that is provided as part of a search result), a selected-from-group format (e.g., a video that is provided in response to a selection made from a slate of available videos), an in-display format (e.g., a video that is provided as a user-selectable thumbnail within a banner or other display), or a stream-embedded format (e.g., a video that is provided before, during or after another content item in a stream). Each format can provide a different context in which the video content item is presented. By way of example, search-result-embedded videos can include videos that consist of a user-selectable thumbnail image or icon that appears inside a search result. For example, this type of format can include three lines of text in addition to the video thumbnail. The format can be used to redirect the user to a video watching web page. Selected-from-group videos can include videos that result from user selection of a single thumbnail from a group (or slate) of thumbnails of videos. In-display videos can include videos that appear as a user-selectable thumbnail in a banner (e.g., at the top of a web page) or in some other type of display context. Stream-embedded videos can include short (e.g., 15-second, 30-second, etc.) videos that play before, during or after video content (e.g., referred to as “pre-rolls,” “mid-rolls,” or “post-rolls”). Other formats are possible, and the methods, systems, user interfaces, etc. that are described in this document can be adapted for the other formats, including formats that apply to mobile devices.

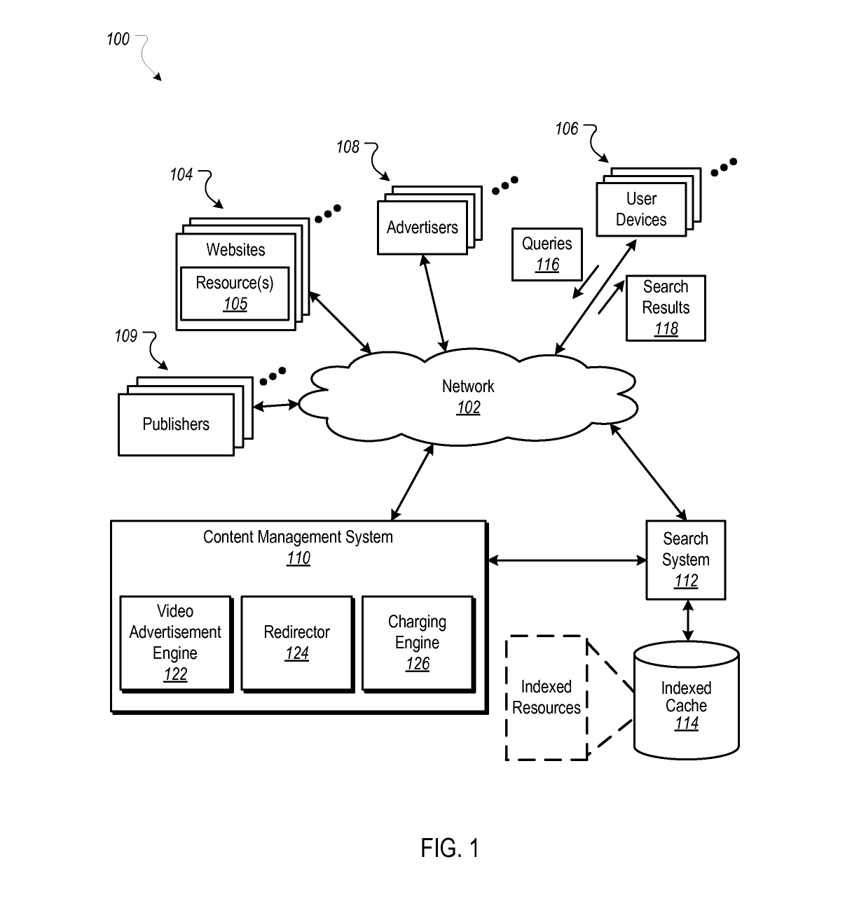

FIG. 1 is a block diagram of an example environment 100 for serving content. The example environment 100 includes a content management system 110, e.g., for selecting and providing content in response to requests for content. The example environment 100 includes a network 102, such as a local area network (LAN), a wide area network (WAN), the Internet, or a combination thereof. The network 102 connects websites 104, user devices 106, content sponsors (e.g., advertisers 108), publishers 109, and the content management system 110. The example environment 100 may include many thousands of websites 104, user devices 106, and content sponsors (e.g., advertisers 108).

In some implementations, the content management system 110 can include plural engines. For example, a video engine 122 can present video advertisements, e.g., on content pages displayed on user devices 106, and determine when each video corresponding to a video advertisement is viewed by the user. When a video advertisement is initially served and displayed on the user device 106, a redirector 124 can redirect from a current address, such as a URL, to a new address. This can occur, for example, if a content page on which the video advertisement is served has a different domain from the web page on which the video is hosted (and can ultimately be played). When the video is presented (e.g., when the user starts to play the video), a charging engine 126 can charge a content sponsor (e.g., an advertiser 108) that is associated with the video with the presentation.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title or video title, a snippet of text or a portion of an image extracted from the web page or video, and the URL of the web page. Search results pages can also include one or more slots in which other content items (e.g., ads) can be presented.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible video ads having characteristics matching the characteristics of ad slots and that are identified as relevant to specified resource keywords or search queries 116. However, in applications in which search queries 116 are not used, the content management system 110 can use other ways of selecting content, e.g., selecting ads based on the format type of a particular ad slot.

The content management system 110 can select from the eligible content items that are to be provided for presentation in slots of a resource or search results page based at least in part on results of an auction. For example, for the eligible content items, the content management system 110 can receive bids from content sponsors (e.g., advertisers) and allocate the slots, based at least in part on the received bids (e.g., based on the highest bidders at the conclusion of the auction). The bids are amounts that the content sponsors are willing to pay for presentation (or selection) of their content with a resource or search results page. For example, a bid can specify an amount that a content sponsor is willing to pay for playing a video associated with a video ad. Alternatively, the bid can specify an amount that the content sponsor is willing to pay for other activities such as a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

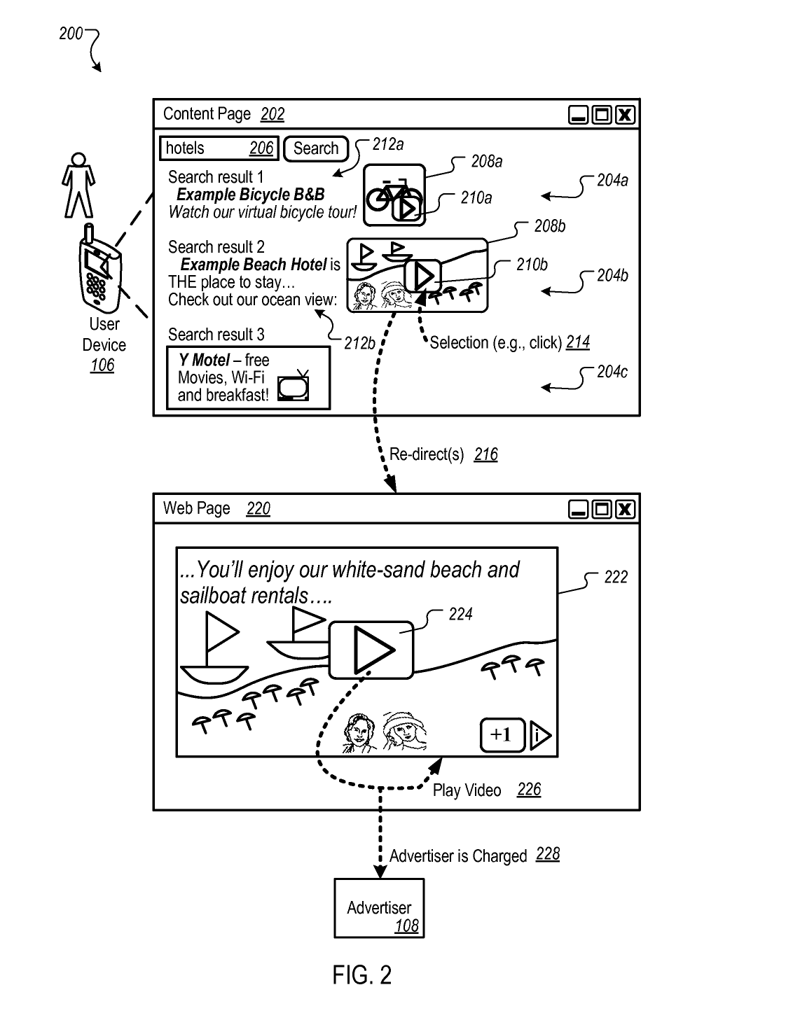

FIG. 2 is a block diagram of a system 200 for charging a content sponsor when an associated video is presented. For example, by charging at presentation time (e.g., when the video is viewed by the user), instead of charging for the initial click, the charge made to the content sponsor can more accurately reflect the actual circumstances of the video presentation. The system 200, for example, can determine the time after the initial click (or other selection of a control on the video ad) when the video is played for the user. The system 200 can then charge the content sponsor associated with the video ad at the determined time as opposed to the time associated with the selection of the control, e.g., when the user initially clicks on a thumbnail associated with the video ad. Example situations in which the video advertisement is clicked but the video is delayed include videos that take a significant time (e.g., a few seconds or more) to load, or videos that can be started with a control that appears after the initial click on the video advertisement. In the first example, the user can cancel or skip the video while it is loading and never view the video. In the second example, the user may decide not to watch the video. In either example, the system 200 can detect the situation that, after selection of the video ad, no playback of the associated video has occurred, and the content sponsor is not charged for the click.

For example, a content page 202 can present video ads 204a and 204b. In some implementations, the video ads 204a and 204b and a non-video ad 204c can be ads on a search result page that include several ads in addition to non-advertising content. For example, the video ads 204a-204c can be ads related to accommodations (e.g., hotels, motels, bed-and-breakfast businesses, etc.). The video ads 204a-204c can be displayed, for example, in response to a search query 210 for “hotels” submitted by a user running a browser or other application on a user device 106. In some implementations, the video ads 204a-204c can be served in other situations not having a search query 210, such as providing ads in a maps application in response to a location (e.g., ads for hotels or other businesses in a geographic area). In the example shown in FIG. 2, the video ads 204a-204c appear on the left side of the content page 202. However, ads such as the video ads 204a-204c can appear anywhere on the content page 202 and can also appear on other web pages.

The video ads 204a and 204b include thumbnails 208a and 208b, respectively, each representing, for example, a full-featured video. For example, the thumbnails 208a and 208b can include still frames (e.g., a bicycle image, a beach photo, etc.) or other images that represent or are otherwise associated with a given video (e.g., a virtual bicycle tour, beach recreation, etc.). The video ads 204a and 204b also include controls 210a and 210b, respectively, for selecting the associated video for playback. For example, each of the controls 210a and 210 can serve as a link to the corresponding video. The video ads 204a and 204b can also include companion text 212a and 212b, respectively, that can introduce or describe each corresponding video, e.g., with a textual description, title, etc. The video ads 204a and 204b can include other components not shown in FIG. 2.

In some implementations, selecting the control 210a does not result in immediately charging the content sponsor, e.g., for an impression of the video ad. Rather, charging the advertiser can wait until the user is actually presented with the video. In some implementations, the click, the presentation and/or other events can occur on different domains. This can require that mechanisms for capturing the occurrence of the presentation can span multiple domains.

For example, the video ads 204a-204c can be served by an advertisement delivery system associated with a first domain, and the subsequent presentation of the video (e.g., where the video runs) can be on a web page that is hosted in a second different domain.

For example, upon user selection (e.g., a click 214) on the control 210b, at least one redirect 216 can occur. The first redirect can be to a first domain associated with an advertisement delivery system that serves the video advertisement. In some implementations, the first redirect can use a code that indicates that the selection of the control is an initial click and not a playback of the video advertisement. The redirect can also identify which ad (e.g., the video ad 204b) from ads 204a-204c on the content page 202 was selected by the user.

In some implementations, a second redirect can occur to a second domain. For example, the second domain can host a web page 220 on which a video 222 associated with the video advertisement 204b can play. The second redirect can set a cookie that records information about how to contact a charging engine and to identify which advertisement for which to record the charge. Playback of the video content item can occur in the second domain, and a determination can be made as to when the presentation of the video 222 to the user starts.

In some implementations, the video 222 can play automatically. In some implementations, the video 222 does not start until, for example, the user selects a start control 224 to initiate play of the video in the second domain. When the video 222 plays 226, the content sponsor (e.g., advertiser 108) associated with the video ad 204b can be charged 228. Charging can occur, for example at the time that the user is presented with the video 222 (or after a user has watched a pre-determined portion of the video 222) as opposed to earlier in the sequence of events, e.g., when the user clicks on the video ad 204b. In some implementations, the second redirect can include instructions that allow billing to occur when the video is played back.

In some implementations, charging the advertiser 108 can include automatically debiting/crediting of various accounts by an ad serving system responsive to the playing. For example, the advertiser's account can be debited, and an offsetting credit can occur to an account on the ad serving system.

In some implementations, reporting systems that are available to the advertiser 108 can provide information about actual plays of the video. For example, the information can correlate video presentations with billing information, identifying what the advertiser 108 has been charged for presentations of the video, including a number of actual plays, or paid views, of the video. In this way, the advertiser 108 can see that there is no discrepancy between the paid views and clicks, and that billing/charging is based on actual presentations of the video.

In some implementations, the reporting systems can be part of an interactions framework that can report and bill for ad formats having multiple interaction types. For example, the interactions framework can serve to log and report to advertisers all of the various interactions that users may have with their video ads, including video ads of different formats.

In some implementations, determining when the user is presented with the video can include determining when the user has been presented a predetermined portion of the video and charging the advertiser only after the predetermined portion has been presented to the user. For example, some advertisers 108 may have predetermined conditions in their ad campaigns that they are not to be charged for an ad unless the user has watched the video sufficiently long enough (e.g., 30 seconds), during which time the user can have skipped the video if desired. In another example, the advertiser 108 can be charged for the presentation of the video if the user has watched 10% or more.

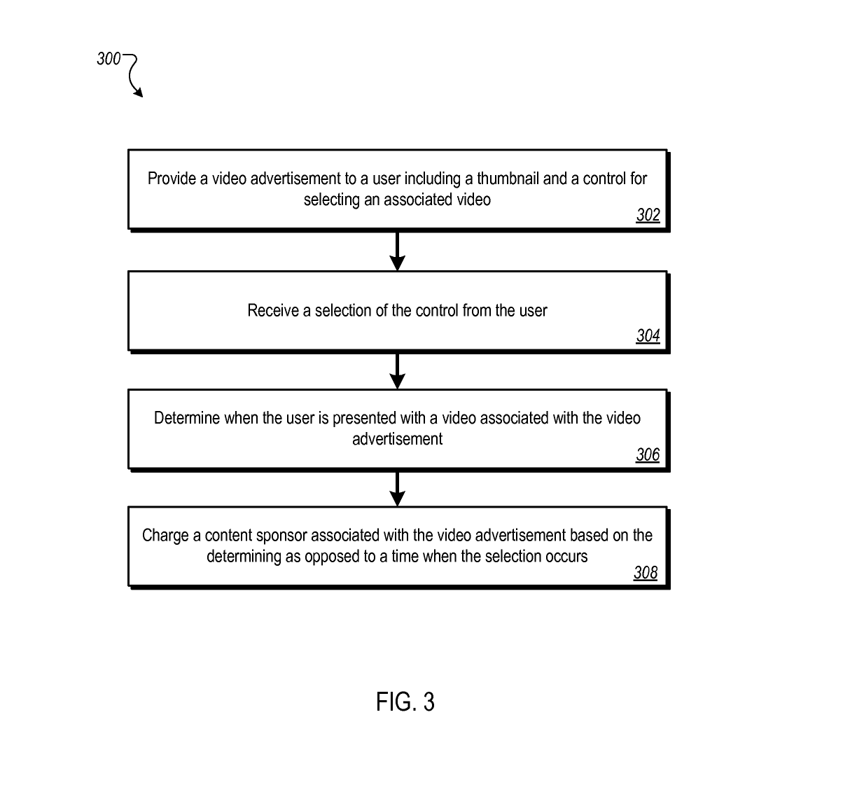

FIG. 3 is a flowchart of an example process 300 for charging a content sponsor when an associated video is presented. The process 300 can be performed by the video engine 122, the redirector 124 and/or charging engine 126. FIGS. 1 and 2 are used to provide examples for steps of the process 300.

A video advertisement is provided to a user in a content page (302). In some implementations, the video advertisement includes a thumbnail associated with the video advertisement and a control for selecting the associated video for playback. For example, the video ad 204b can appear on the content page 202 which can be displayed on a user device 106. The video ad 204b can include a control 210b for initiating playback of the associated video.

A selection of the video (e.g., a selection of the control) is received from the user (304). As an example, the user can click on the control 210b to select the video associated with the ad 204b for playback.

A determination is made when the user is presented with the video (306). For example, the video engine 122 can determine when the user is presented with the video 222. In some implementations, determining when playback occurs can be facilitated using a cookie that is set during a second redirect, as described above.

A content sponsor associated with the video advertisement is charged based on the determining as opposed to a time when the selection occurs (308). For example, the charging engine 126 can charge the advertiser 108 associated with the video ad 204b based on the determining when the user is presented with the video 222 as opposed to a time when the selection occurs (e.g., clicking the control 210b).

In some implementations, charging the content sponsor can depend on user actions to skip the video or whether the user watches a predetermined portion of the video to warrant charging the advertiser. For example, some types of videos provide an option within the first five seconds of the video for the user to skip the video (e.g., as an “opt-out”). If the user skips the video within a predetermined time, then the advertiser is not charged. However, it the user watches the video at least throughout the predetermined time that skipping the video is an option, then this can be considered a view event, and the advertiser can be charged. In some implementations, a view event can represent a threshold time (e.g., 30 seconds) in which it is believed that the user has had the chance to skip the video but instead has decided to watch the video. For example, the advertiser can be charged for the video if the threshold time is reached or when the video finishes, whichever comes first. For a 15-second video, for example, the view event can occur at 15 seconds. For a 45-second video, for example, the view event can occur at 30 seconds into the video.

In some implementations, another method can be used for charging a content sponsor for the presentation of a video, where the method can include the following steps. A selection of a video content item is received from a user. As an example, the selection can be a click by the user on the control 210b to select the video ad 204b for playback of the video content item associated with the video ad 204b. The advertiser associated with the video content item is not charged when the click occurs but based on determining a time when the video content item is presented to the user. For example, the advertiser 108 can be charged, not when the user clicks on the control 210b, but instead at the time that the video content item is presented to the user.

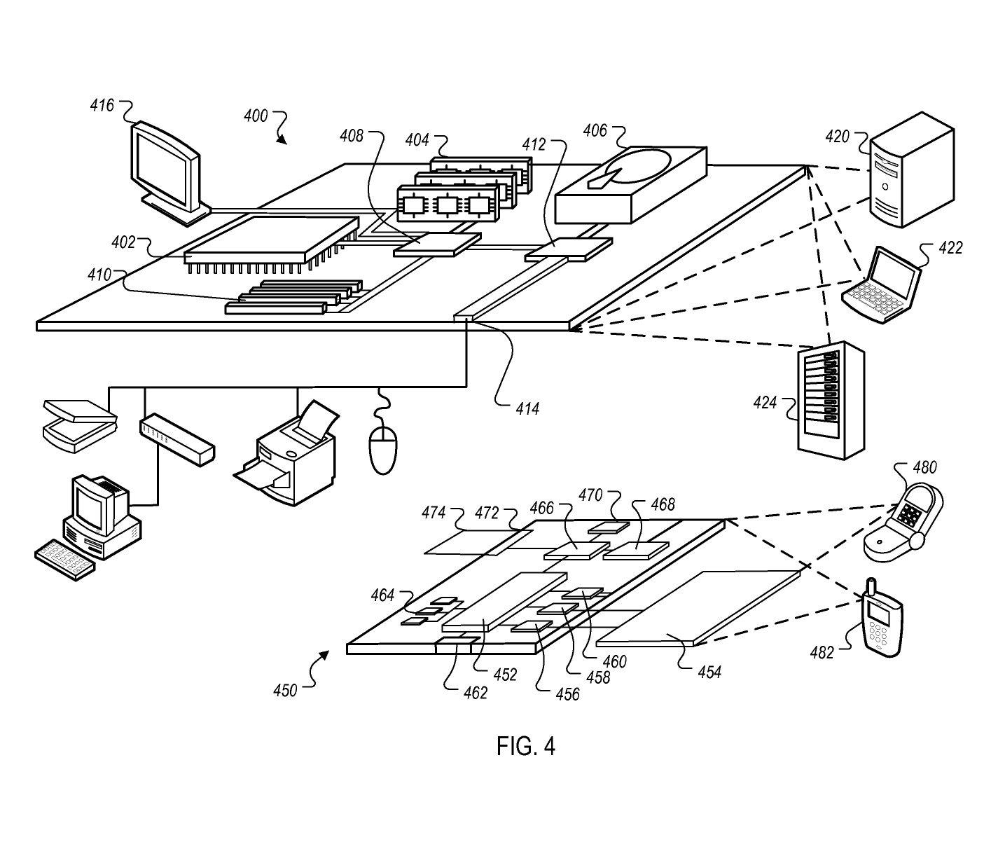

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
providing a video advertisement to a user in a content page where the video advertisement includes a control for selecting an associated video for playback;
receiving, from the user, a selection of the control;
determining when the user is presented with the video; and
charging an advertiser associated with the video advertisement based on the determining as opposed to a time when the selection occurs.

2. The method of claim 1 where the control is a link to the video.

3. The method of claim 1 where the content page is a search result page that includes a plurality of advertisements.

4. The method of claim 3 where the search result page includes a plurality of video advertisements.

5. The method of claim 1 where the determining includes determining a time after the selection of the control when the video is played for the user.

6. The method of claim 5 further comprising charging the advertiser associated with the video advertisement at the determined time as opposed to the time associated with the selection of the control.

7. The method of claim 1 where the selection of the control comprises a click and the method further comprising determining after the click that no playback of the video occurred and not charging the advertiser for the click.

8. The method of claim 1 further comprising, after receipt of the selection, generating a first redirect for designating which advertisement from a plurality of advertisements on the content page was selected by the user to a domain associated with an advertisement delivery system that provides the video advertisement.

9. The method of claim 1 where the video advertisement is served by an advertisement delivery system associated with a first domain and where the video plays on a web page that is hosted in a second different domain and where the method further comprises, after receipt of the selection, generating a first redirect to the first domain that records the click and generating a second redirect to the second domain to set a cookie that records information about how to contact a charging engine and to identify which advertisement for which to record the charge.

10. The method of claim 9 where the first redirect uses a code that indicates that the selection of the control is an initial click and not a playback of the video.

11. The method of claim 9 where the second redirect includes instructions that allow billing to occur when the video is played back.

12. The method of claim 1 where determining when the user is presented the video includes determining when the user has been presented a predetermined portion of the video and charging the advertiser only after the predetermined portion has been presented to the user.

13. The method of claim 12 where the predetermined portion is a portion that is sufficiently long to enable the user to have skipped the video if desired.

14. The method of claim 12 where the predetermined portion is a predetermined percentage of the video.

15. A method comprising:
receiving a selection from a user of a video content item including a click on an advertisement associated with the video content item;
not charging the advertiser associated with the video content item when the click occurs rather determining a time when the video content item is presented to the user; and
charging the advertiser at the time that the video content item is presented to the user.

16. A content management system that provides content items responsive to received requests, the content management system including:
a video engine that presents a video advertisement to a user and determines when the user is presented with an associated video, where the video advertisement is served by an advertisement delivery system associated with a first domain;
a redirector that rewrites a uniform resource locator (URL) prior to processing by a web server, where the redirector generates a first redirect for designating which advertisement from a plurality of advertisements on a content page was selected by the user to a domain associated with an advertisement delivery system that provides the video advertisement, and where the redirector generates a second redirect to a second domain to set a cookie that records charging information, the charging information including identification of the advertisement for which to record the charge; and
a charging engine for charging an advertiser associated with the video advertisement based on the recorded charging information and further based on determining when the user is presented with the associated video as opposed to a time when the selection occurs.

17. A computer program product tangibly embodied in a computer-readable storage device and comprising instructions that, when executed by a processor, perform a method for providing content, the method comprising:
providing a video advertisement to a user in a content page where the video advertisement includes a control for selecting an associated video for playback;
receiving, from the user, a selection of the control;
determining when the user is presented with the video; and
charging an advertiser associated with the video advertisement based on the determining as opposed to a time when the selection occurs.
